(19) United States
(12) Patent Application Publication
(10) Pub. No.: US 2009/0154863 A1
(43) Pub. Date: Jun. 18, 2009

(54) DEVICE FOR DECOUPLING A BEARING BRACKET

(75) Inventors: Eric Nicolas DECERLE, Savigny Le Temple (FR); Thierry Francois Maurlce Duchatelle, Creteil (FR); Olivier Michael Molinari, Avon (FR); Arnaud Sanchez, Brunoy (FR)

Correspondence Address: OBLON, SPIVAK, MCCLELLAND MAIER & NEUSTADT, P.C., 1940 DUKE STREET, ALEXANDRIA, VA, 22314, US

(73) Assignee: SNECMA, Paris (FR)

(21) Appl. No.: 12/333,610

(22) Filed: Dec. 12, 2008

(30) Foreign Application Priority Data
Dec. 14, 2007 (FR) 07 08704

(51) Int. Cl. F16C 35/06; F01D 25/16

(52) U.S. Cl. 384/585; 415/229

(57) ABSTRACT

The invention relates to a device for decoupling a bearing bracket in a turbomachine, said bearing bracket having an upstream part and a downstream part respectively comprising a plurality of upstream holes and downstream holes through which stress-limiting screws pass, which device comprises, between each upstream hole and the stress-limiting screw that passes through it, a clearance that prevents any contact between the upstream hole and the stress-limiting screw, and is a device wherein the upstream part and the downstream part of the bearing bracket are in mutual contact via surfaces that form a dual centering means.

### BACKGROUND OF THE INVENTION

The present invention relates to a device for decoupling the bracket of a bearing of a rotating shaft in a turbomachine. A bearing bracket such as this is liable to break its connection with the turbomachine stator upon the onset of imbalance in order to avoid damage to the turbomachine.

A turbomachine comprises, for upstream to downstream in the direction in which the gases flow, a compressor, a combustion chamber and a turbine. The purpose of the compressor is to raise the pressure of the air supply to the combustion chamber. The purpose of the turbine is to drive the rotation of the compressor by tapping off some of the pressure energy of the hot gases leaving the combustion chamber and converting it into mechanical energy.

The compressor and the turbine are made of a first set of fixed parts that make up the stator and of a second set of parts capable of being rotated relative to the stator and which make up the rotor.

The compressor rotor and the turbine rotor form an assembly securely connected by a rotating shaft. Rotation of the rotor with respect to the stator is rendered possible by means of bearings, a bearing being a mechanical component that supports and guides a rotor, particularly the shaft of this rotor. This bearing comprises a first part fixed to the rotor shaft and a second part fixed to the stator via a bearing bracket. A rolling bearing assembly is positioned between the two parts of the bearing, thus allowing one part of the bearing to rotate relative to the other. The rolling bearing assembly may, for example, be of the ball bearing, cylindrical roller bearing or taper roller bearing type.

A turbomachine may also be of the “twin spool” type, which means that it has two rotors arranged coaxially, a bearing allowing relative rotation of these two rotors one with respect to the other.

A turbomachine may also comprise a fan, that constitutes the first stage of the compressor. The fan has very large blades known as fan blades, which increase the mass and inertia of the rotor.

If a fan blade breaks, imbalance appears on the shaft supporting the fan. Imbalance is a phenomenon that affects the balance of the rotor, the center of gravity of which no longer lies precisely on the axis of rotation as it should. Cyclic loadings and substantial vibrations are thus imparted to the turbomachine stator, via the bearing bracket, with a great risk of damage that could lead to self-destruction. In order to prevent these undesirable phenomena from being transmitted to the stator, it is necessary to decouple the bearing bracket, that is to say to interrupt the mechanical transmission of the rotation, particularly by disconnecting the two parts that form the bearing bracket.

### DESCRIPTION OF THE PRIOR ART

Document FR 2877046 describes a solution that consists in using stress-limiting screws to attach an upstream part and a downstream part that form a bearing bracket. These stress-limiting screws, the operation of which is described at length in this document, have a portion of reduced cross section liable to rupture under a tension that exceeds a predetermined tension, thus decoupling the two parts that constitute the bearing bracket.

The stress-limiting screw of FIG. 9 of document FR 2877046 passes through an upstream hole in an upstream part and through a downstream hole in a downstream part of a bearing bracket, the downstream part of the bearing bracket forming an integral part of the casing. The screw head of the stress-limiting screw is adjacent to the hole in the upstream part and is in contact with this upstream part along a plane perpendicular to the axis of the hole. That portion of the stress-limiting screw that passes through the hole is in contact with the inside of the hole via a centering portion. When imbalance appears, the upstream part and the downstream part shift relative to one another in a circular relative movement which has the effect of subjecting the stress-limiting screw to shear forces, because of the tangential contact around the stress-limiting screw, and this may lead to uncontrolled breakage of the stress-limiting screws. Now, these stress-limiting screws are designed for tensile forces only and take no account of shear forces. It is also difficult to design a stress-limiting screw that is capable of accounting both for tensile forces and shear forces.

### SUMMARY OF THE INVENTION

One object of the present invention is to improve the control over the decoupling function. This object is achieved by eliminating the shear forces that may arise in a stress-limiting screw of a device for decoupling a bearing bracket. Thus, the stress-limiting screws become sensitive only to the tensile forces for which they were designed.

To this end, the invention relates to a device for decoupling a bearing bracket in a turbomachine, said bearing bracket having an upstream part and a downstream part respectively comprising a plurality of upstream holes and downstream holes through which stress-limiting screws pass.

According to the invention, the device for decoupling a bearing bracket comprises, between each upstream hole and the stress-limiting screw that passes through it, a clearance that prevents any contact between the upstream hole and the stress-limiting screw. The upstream part and the downstream part of the bearing bracket are in mutual contact via surfaces that form a dual centering means. Advantageously, this clearance prevents shear forces on the stress-limiting screw in the event of imbalance.

The dual centering means may for example consist of a circular groove and a circular rib of complementing shape. The centering function is therefore no longer borne by the stress-limiting screws but is borne directly by the upstream and downstream parts of the bearing bracket. Advantageously, the stress-limiting screws are thenceforth subjected only to tensile forces thus giving better control over the decoupling of the bearing bracket.

### BRIEF DESCRIPTION OF THE DRAWINGS

Other features and advantages of the invention will become more clearly apparent and will be more fully understood in the light of the description detailed hereinbelow, by way of nonlimiting example, in relation to the following figures which, in turn, depict:

FIG. 1: a perspective view of one example of a bearing bracket;

FIG. 2: a schematic view in half section of a first exemplary embodiment of the centering of the bearing bracket;

FIG. 3: a schematic view in axial half section of a second exemplary embodiment of the centering of the bearing bracket;

FIG. 4: a schematic view in section on A-A of FIG. 2;

FIG. 5: a schematic view in section on B-B of FIG. 3;

FIGS. 6 to 9: schematic views in axial half section of a number of exemplary embodiments of the dual centering of the bearing bracket according to the invention; and

FIG. 10: a schematic view in section of a stress-limiting screw attached to a bearing bracket according to the invention.

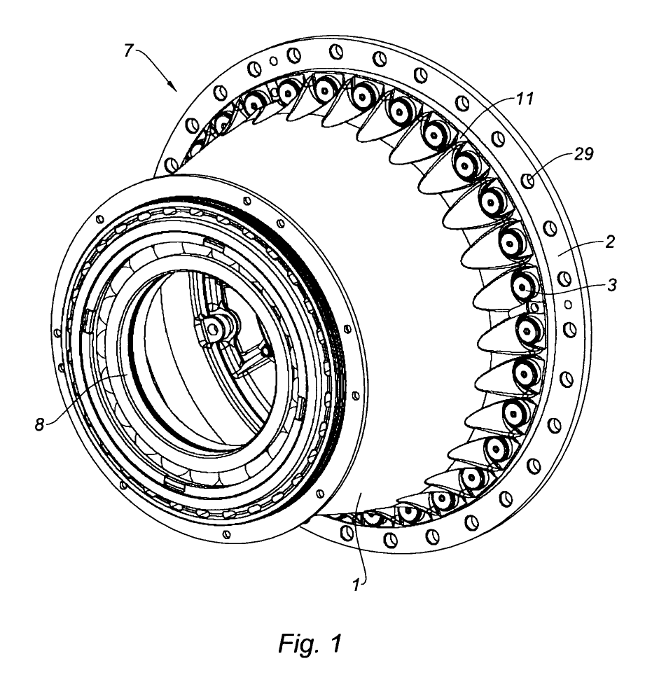

A bearing bracket 7, as depicted in FIG. 1, has an essentially frustoconical shape that comprises an upstream part 1 and a downstream part 2. One end of the upstream part 1 of the bearing bracket 7 is secured to the bearing 8 that supports and guides the turbomachine rotor. The other end of the upstream part 1 of the bearing bracket 7 has a flange 11. The downstream part 2 of the bearing bracket 7 is in the form of a flange 21 and is fixed securely to the turbomachine stator using bolts of the non-stress-limiting type (these have not been depicted) passing through the holes 29. The upstream part 1 and the downstream part 2 of the bearing bracket 7 respectively comprise, in the region of their flanges 11 and 21, a plurality of circular holes 10 and 20 and are connected together by a plurality of stress-limiting screws 3 which pass in succession through a hole 10 in the upstream part 1 and through a hole 20 in the downstream part.

In a non-optimal configuration, the centering of the upstream part 1 with respect to the downstream part 2 of the bearing bracket 7, that is to say the axial alignment thereof, may be afforded by complementing shapes of a circular rib 12 or 23 and a circular shoulder 22 or 13 on one or other of the upstream 1 and downstream 2 parts of the bearing bracket 7. Within the meaning of the present invention, a shoulder is defined as an abrupt change in cross section of a component in order to obtain a bearing surface.

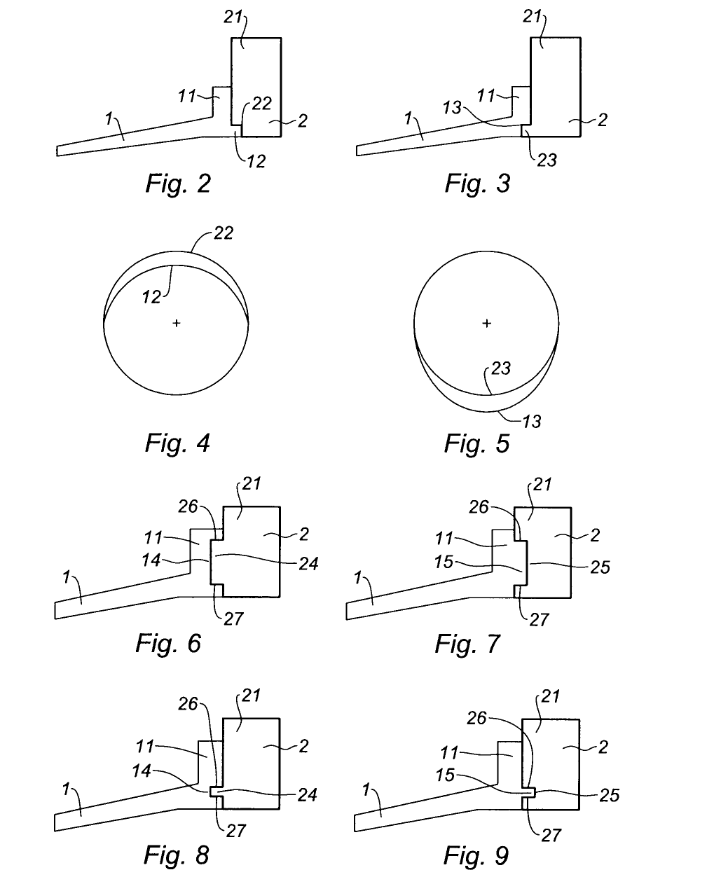

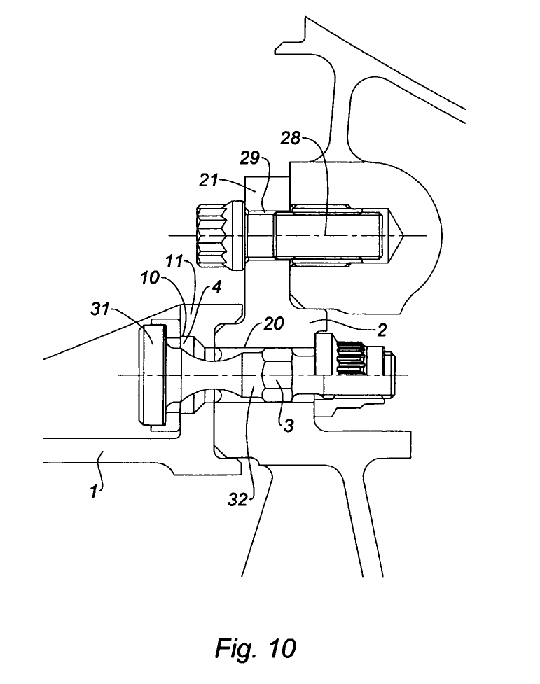

In the example of FIG. 2 which depicts single centering known as “external” centering, the circular rib 12 is located on the upstream part 1 and the circular shoulder 22 is located on the downstream part 2. In the event of imbalance, the bearing bracket deforms, becoming ovalized. When this happens, tangential contact between the circular rib 12 and the circular shoulder 22 is lost over part of the circumference, as depicted in FIG. 4. This gap between the circular rib 12 and the circular shoulder 22 causes the stress-limiting screws 3 to shear.

Likewise, in the example of FIG. 3, which depicts single centering of the “internal” centering type, the circular shoulder 13 being located on the upstream part 1 and the circular rib 23 being located on the downstream part 2, in the event of imbalance, the tangential contact between the circular shoulder 13 and the circular rib 23 is lost over part of the circumference as depicted in FIG. 5. This gap between the circular shoulder 13 and the circular rib 23 again causes the stress-limiting screws 3 to shear.

However, this shear is far less significant than in the case of FIG. 1 of document FR 2877046 that forms part of the prior art in which the centering function is afforded only by the stress-limiting screws, thus giving rise to even greater shear.

In these three examples, control over the tensile force at which the stress-limiting screws break is liable to be disrupted by shear forces.

### DESCRIPTION OF THE PREFERRED EMBODIMENTS

In order to lessen, or even eliminate, the shear forces on the stress-limiting screws 3, a first part of the solution proposed by the invention is to replace the external 12 and 22 or internal 13 and 23 centering means, which are single centering means, with a means known as a “dual centering” means.

The dual centering means, 14 and 24 or 15 and 25, consists of a circular groove 14 or 25 and a circular rib 15 or 24 of complementing shape. The circular groove 14 or 25 and the circular rib 15 or 24 are in contact via their flanks 26 and 27 that offer two parallel contact surfaces. “Dual centering” thus provides centering by means of these two parallel surfaces whereas a single centering means like the one depicted in FIGS. 2 and 3 offers just one contact surface for centering.

According to a first embodiment of the invention which is depicted in FIG. 6, the circular groove 14 is located on the upstream part 1 and the circular rib 24 is located on the downstream part 2. In this first alternative form of this first embodiment, the circular groove 14 and the circular rib 24 of complementing shapes are wide. In a second alternative form of this first embodiment, the circular groove 14 and the circular rib 24 of complementing shape are narrow, as depicted in FIG. 8.

According to a second embodiment of the invention which is depicted in FIG. 7, the circular rib 15 is located on the upstream part 1 and the circular groove 25 is located on the downstream part 2. In this first alternative form of this second embodiment, the circular rib 15 and the circular groove 25 of complementing shape are wide. In a second alternative form of this second embodiment, the circular rib 15 and the circular groove 25 of complementing shape are narrow, as depicted in FIG. 9.

In all the embodiments and alternative forms introduced hereinabove, the collaboration between a groove 14 or 25 and rib 15 or 24 of complementing shape makes it possible to lessen, or even eliminate, the deformation of the bearing bracket 5 through ovalization by keeping permanent contact between the flanks 26 and 27 of the circular groove 14 or 25 and of the circular rib 15 or 24.

In order further to lessen, or even eliminate, the shear forces on the stress-limiting screws 3, a second part of the solution proposed by the invention is to eliminate all contact between each upstream hole 10 and the stress-limiting screw 3 that passes through it. Thus, since a shift of the upstream part 10 of the bearing bracket 7 can no longer cause a stress-limiting screw to move through tangential contact around this stress-limiting screw 3, these stress-limiting screws 3 are now subjected only to tensile forces, thus providing better control over the decoupling of the bearing bracket 7.

The elimination of the contact between each upstream hole 10 and the stress-limiting screw 3 passing through it may be achieved by providing a clearance 4 between the stress-limiting screw 3 and the upstream hole 10 in which it is held. More specifically, the clearance 4 has to be such that there can be no contact between the interior surface of the hole 10 and the shank 32 of the stress-limiting screw 3.

The clearance 4 may be formed by a circular counterbore 11 bored in the upstream hole 10. A counterbore being, within the meaning of the present invention, a cavity created in a part. The circular counterbore 11 has a diameter greater than the diameter of the upstream hole 10, which means that it is possible to continue to use stress-limiting screws 3 of the prior art that have a centering portion, referenced 19 in FIG. 9 of document FR 2877046. Even though this centering portion no longer serves any purpose in the context of the invention, it is nonetheless advantageous to use the standard stress-limiting screws 3, the properties, particularly in terms of ultimate tensile strength, of which are well known and controlled.

The overall inventive idea also relates to a turbomachine comprising a device for decoupling a bearing bracket according to the invention.

1. A device for decoupling a bearing bracket in a turbomachine, said bearing bracket having an upstream part and a downstream part respectively comprising a plurality of upstream holes and downstream holes through which stress-limiting screws pass, which device comprises, between each upstream hole and the stress-limiting screw that passes through it, a clearance that prevents any contact between the upstream hole and the stress-limiting screw, and is a device wherein the upstream part and the downstream part of the bearing bracket are in mutual contact via surfaces that form a dual centering means.

2. The device for decoupling a bearing bracket as claimed in claim 1, wherein the clearance is formed by a circular counterbore bored in the upstream hole.

3. The device for decoupling a bearing bracket as claimed in claim 1, wherein the dual centering means consists of a circular groove and a circular rib of complementing shape.

4. A device for decoupling a bearing bracket as claimed in claim 3, wherein the circular groove is located on the upstream part and the circular rib is located on the downstream part.

5. The device for decoupling a bearing bracket as claimed in claim 3, wherein the circular groove is located on the downstream part and the circular rib is located on the upstream part.

6. The device for decoupling a bearing bracket as claimed in claim 3, wherein the circular groove and the circular rib are in contact via flanks that offer parallel surfaces.

7. A turbomachine comprising a device for decoupling a bearing bracket as claimed in one of the preceding claims.
